(19) United States
(12) Patent Application Publication
(10) Pub. No.: US 2025/0211451 A1
(43) Pub. Date: Jun. 26, 2025

(54) SECURE ARCHITECTURE FOR 3RD-PARTY MANAGEMENT OF ORGANIZATIONAL APPLICATION RESOURCES

(71) Applicant: AponoTech Ltd., Tel Aviv (IL)

(72) Inventor: Ofir STEIN, Tel Aviv (IL)

(21) Appl. No.: 18/988,705

(22) Filed: Dec. 19, 2024

Related U.S. Application Data
(60) Provisional application No. 63/613,245, filed on Dec. 21, 2023.

(51) Int. Cl. H04L 9/32; H04L 9/08; H04L 9/40

(52) U.S. Cl. CPC H04L 9/3247; H04L 9/0838; H04L 9/3273; H04L 63/0442

(57) ABSTRACT

A system of compromise-resistant configuration of an application, comprising a processing circuitry configured to: utilize an authenticated secure communication channel to a configuration agent that has access to one or more secrets associated with an organization, usable for configuring respective applications of the organization; receive, from a user, a request of configuration of an application, the request including a cryptographic signature of a user of the organization, the signature utilizing a key derivative of a mutual authentication between the user and the configuration agent; derive, from the received request of configuration application configuration commands; transmit, to the application configuration agent, via the authenticated secure communication channel: the request of configuration of the first user, wherein the request comprises the cryptographic signature, and the derived application configuration commands; thereby providing an attestation of integrity of the commands.

### CROSS REFERENCE TO RELATED APPLICATIONS

This application claims the benefit of priority of U.S. Provisional Patent Application No. 63/613,245, filed Dec. 21, 2023, the contents of which are all incorporated herein by reference in their entirety.

### TECHNICAL FIELD

The presently disclosed subject matter relates to configuration of applications in an organization's information technology infrastructure, and in particular to maintaining security and integrity in such systems.

### BACKGROUND

Problems of secure management of applications in networked computer systems have been recognized in the conventional art and various techniques have been developed to provide solutions.

### GENERAL DESCRIPTION

According to one aspect of the presently disclosed subject matter there is provided a computer system of compromise-resistant configuration of an application, the system comprising a processing circuitry (PC) configured to:
a) utilize an authenticated secure communication channel to a configuration agent, the configuration agent having access to one or more secrets, associated with a first organization, usable for configuring respective applications of the first organization;
b) receive, from a first user, a request of configuration of an application, the request including a cryptographic signature of a first user of the first organization, the signature utilizing a key derivative of a mutual authentication between the first user and the configuration agent;
c) derive, from the received request of configuration of the first user, a one or more application configuration commands;
d) transmit, to the application configuration agent, via the authenticated secure communication channel, at least:
   i) at least part of the request of configuration of the first user, wherein the at least part of the request comprises the cryptographic signature, and
   ii) at least one of the derived application configuration commands;
thereby providing an attestation of integrity to application configuration commands.

According to another aspect of the presently disclosed subject matter there is provided a computer-implemented method of compromise-resistant configuration of an application, the method comprising:
a) utilizing an authenticated secure communication channel to a configuration agent, the configuration agent having access to one or more secrets, associated with a first organization, usable for configuring respective applications of the first organization;
b) receiving, from a first user, a request of configuration of an application, the request including a cryptographic signature of a first user of the first organization, the signature utilizing a key derivative of a mutual authentication between the first user and the configuration agent;
c) deriving, from the received request of configuration of the first user, a one or more application configuration commands;
d) transmitting, to the application configuration agent, via the authenticated secure communication channel, at least:
   i) at least part of the request of configuration of the first user, wherein the at least part of the request comprises the cryptographic signature, and
   ii) at least one of the derived application configuration commands;
thereby providing an attestation of integrity to application configuration commands.

According to another aspect of the presently disclosed subject matter there is provided a computer program product comprising a computer readable non-transitory storage medium containing program instructions, which program instructions when read by a processor, cause the processing circuitry to perform a method compromise-resistant configuration of an application, the method comprising:
a) utilizing an authenticated secure communication channel to a configuration agent, the configuration agent having access to one or more secrets, associated with a first organization, usable for configuring respective applications of the first organization;
b) receiving, from a first user, a request of configuration of an application, the request including a cryptographic signature of a first user of the first organization, the signature utilizing a key derivative of a mutual authentication between the first user and the configuration agent;
c) deriving, from the received request of configuration of the first user, a one or more application configuration commands;
d) transmitting, to the application configuration agent, via the authenticated secure communication channel, at least:
   i) at least part of the request of configuration of the first user, wherein the at least part of the request comprises the cryptographic signature, and
   ii) at least one of the derived application configuration commands;
thereby providing an attestation of integrity to application configuration commands.

According to another aspect of the presently disclosed subject matter there is provided a computer system of compromise-resistant configuration of an application, the system comprising a processing circuitry (PC) configured to:
a) maintain application-specific configuration secrets of a first organization, and utilize an authenticated secure communication channel to a manager;
b) perform mutual authentication to establish a secure association with a first user of the first organization;
c) receive, from the manager, at least:
   i) a request of the first user of application configuration, the request including a cryptographic signature of the first user, and
   ii) one or more commands of configuring a first application;
d) responsive to:
   i) based on the secure association with the first user, cryptographically verifying the first user as the origin of the request, and verifying the message integrity of the request, and that the signature of the request is of the first user, and
   ii) verifying that the one or more commands of configuring are technically appropriate to performing the received request of the first user,
utilize a secret specific to the first application to configure the first application, in accordance with the one or more commands.

In addition to the above features, the system according to this aspect of the presently disclosed subject matter can comprise additional feature (i):
(i) the processing circuitry is further configured to:
   e) receive a credential from the first application;
   f) encrypt the credential using an encryption key decryptable by the first user; and
   g) transmit the encrypted credential to the management system via the secure authenticated channel.

According to another aspect of the presently disclosed subject matter there is provided a computer-implemented method of compromise-resistant configuration of an application, the method comprising:
a) maintaining application-specific configuration secrets of a first organization, and utilizing an authenticated secure communication channel to a manager;
b) performing mutual authentication to establish a secure association with a first user of the first organization;
c) receiving, from the manager, at least:
   i) a request of the first user of application configuration, the request including a cryptographic signature of the first user, and
   ii) one or more commands of configuring a first application;
d) responsive to:
   i) based on the secure association with the first user, cryptographically verifying the first user as the origin of the request, and verifying the message integrity of the request, and that the signature of the request is of the first user, and
   ii) verifying that the one or more commands of configuring are technically appropriate to performing the received request of the first user,
utilizing a secret specific to the first application to configure the first application, in accordance with the one or more commands.

This aspect of the disclosed subject matter can further optionally comprise (i) listed above with respect to the system, mutatis mutandis, in any desired combination or permutation which is technically possible.

According to another aspect of the presently disclosed subject matter there is provided a computer program product comprising a computer readable non-transitory storage medium containing program instructions, which program instructions when read by a processor, cause the processing circuitry to perform a method of drawing a fluid from a fluid container into a syringe, the method comprising:
a. maintaining application-specific configuration secrets of a first organization, and utilizing an authenticated secure communication channel to a manager;
b. performing mutual authentication to establish a secure association with a first user of the first organization;
c. receiving, from the manager, at least:
   i) a request of the first user of application configuration, the request including a cryptographic signature of the first user, and
   ii) one or more commands of configuring a first application;
d. responsive to:
   i) based on the secure association with the first user, cryptographically verifying the first user as the origin of the request, and verifying the message integrity of the request, and that the signature of the request is of the first user, and
   ii) verifying that the one or more commands of configuring are technically appropriate to performing the received request of the first user,
utilizing a secret specific to the first application to configure the first application, in accordance with the one or more commands.

This aspect of the disclosed subject matter can further optionally comprise (i) listed above with respect to the system, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an example deployment of Software-as-a-Service (SaaS) management of application configuration agents in a customer environment, in accordance with some embodiments of the presently disclosed subject matter;

FIG. 2 illustrates a block diagram of an example of application configuration agent, in accordance with some embodiments of the presently disclosed subject matter;

FIG. 3 illustrates a time diagram of an example end-to-end application configuration sequence, in accordance with some embodiments of the presently disclosed subject matter;

FIG. 4 illustrates a flow diagram of an example compromise-resistant method of receiving a client access request and commanding a application configuration agent in response to the request, in accordance with some embodiments of the presently disclosed subject matter; and

FIG. 5 illustrates a flow diagram of an example compromise-resistant method of configuring an application in response to commands originated by a policy workflow, in accordance with some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “encrypting”, “decrypting”, “determining”, “calculating”, “receiving”, “providing”, “obtaining”, “emulating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

The present disclosure describes, in some embodiments, an architecture that enables a third-party manager platform (e.g. a software-as-a-service provider) to provide an organization with workflow management and administration of sensitive proprietary information technology resources, while providing mechanisms in the organization resources to the limit any risk of allowing 3^{rd} party management by identifying and filtering any management commands lacking association with cryptographically valid user requests, as will be described in detail below.

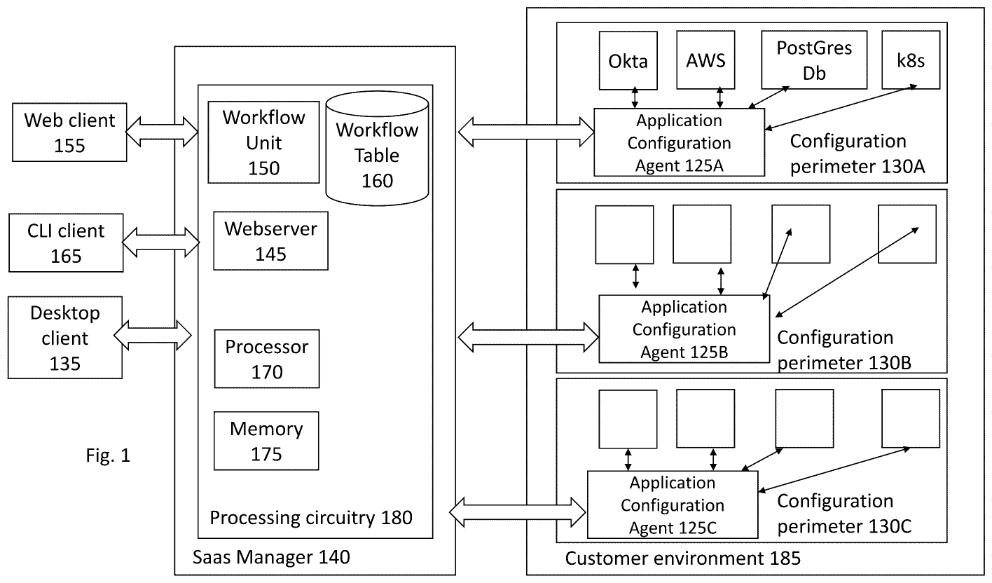

Attention is now drawn to FIG. 1, which illustrates an example deployment of Software-as-a-Service (SaaS) management of application configuration agents in a customer environment, in accordance with some embodiments of the presently disclosed subject matter.

Customer environment 185 can include various types of computing infrastructure which support and execute applications utilized by a particular organization. Customer environment 185 can include, by way of non-limiting example:
physical servers and associated applications in a private data center,
different cloud environments, which can in turn include various servers, containers, applications, workloads
communication and data storage devices

Customer environment 185 can be divided to any number of configuration perimeters 130A 130B 130C. A configuration perimeter can be a subset of resources of customer environment 185 to which a particular set of best practices apply. By way of non-limiting example: an organization can maintain separate configuration perimeters for
different physical premises/cloud providers e.g. one configuration perimeter for Amazon Web Services™ resources, a second configuration perimeter for Microsoft Azure™ resources, and a third configuration perimeter for a physical data center
different organizational purposes (e.g. production vs. development vs. testing)

In some examples, each configuration perimeter 130A 130B 130C is associated with a distinct application configuration agent 125A 125B 125C.

Application configuration agent 125A 125B 125C can be, for example, a software module programmed to perform configuration on application resources located with a particular configuration perimeter.

By way of non-limiting example, configuration perimeter 130A can include several applications shown here: Okta™, Amazon Web Services™ (AWS), PostgresDB™, and Kubernetes™. Application configuration agent 125A can perform configuration on all of these applications—for example: in response to commands from SaaS manager 140.

Details on components and capabilities of application configuration agent 125A 125B 125C appear below, with reference to FIG. 1B.

Application configuration agent 125A 125B 125C can execute, for example, on a dedicated computer, or in a container on a multiprocessing system, or any other suitable system configuration.

SaaS manager 140 can be a management service providing a value-added solution for configuration of services in customer environments.

In some examples, SaaS manager 140 is a publicly available website from which various organizations purchase subscriptions. SaaS manager 140 can provide an administrative web interface to define policies regarding configuration of applications in customer environment 185. SaaS manager 140 can provide a web interface to enable members of the organization to request configuration changes (e.g. receiving temporary access to a database or application) via a web client 155. SaaS manager 140 can also provide a command line interface (CLI) to a CLI client 165 (e.g. via standard internet transport protocols). SaaS manager 140 can also provide another suitable interface to e.g. a user-interface-oriented desktop client 135.

SaaS manager 140 can communicate with application configuration agents 125A 125B 125C—for example via authenticated connections (e.g. transport layer security (TLS), websocket etc.). SaaS manager 140 can issue configuration commands to application configuration agents 125A 125B 125C as described in detail below with reference to FIG. 1C.

SaaS manager 140 can include processing circuitry 180, which in turn can include processor 170 and memory 175.

Processor 170 can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 170 can also consist, for example, of multiple processors, multiple ASICs, virtual processors, combinations thereof etc.

Memory 175 can be, for example, a suitable kind of volatile and/or non-volatile storage, and can include, for example, a single physical memory component or a plurality of physical memory components. Memory 175 can also include virtual memory. Memory 175 can be configured to, for example, store various data used in computation.

Processing circuitry 180 can be configured to execute several functional modules in accordance with computer-readable instructions implemented on a non-transitory computer-readable storage medium. Such functional modules are referred to hereinafter as comprised in the processing circuitry. These modules can include, for example, webserver 145, workflow unit 150, and workflow unit 160.

Webserver 145 can enable access to SaaS management services from web clients/web browsers.

Workflow table 160 and workflow unit 150 can implement workflow policy functionality, as described in detail below.

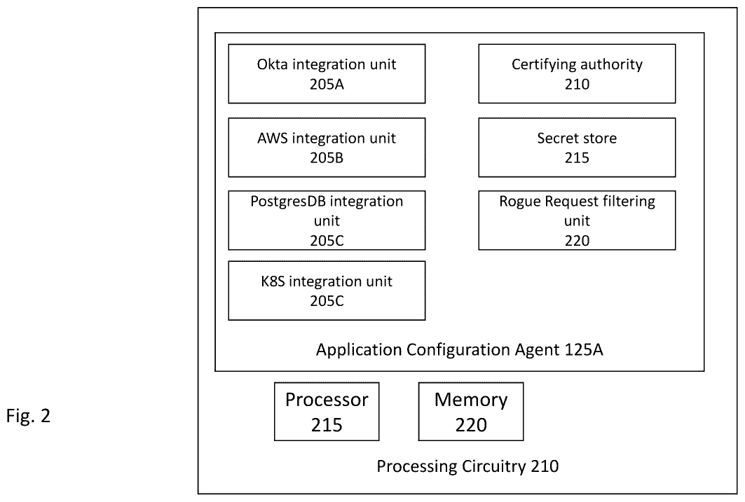

Attention is now drawn to FIG. 2, which illustrates a block diagram of an example of application configuration agent, in accordance with some embodiments of the presently disclosed subject matter.

Application configuration agent 125A can be comprised in processing circuitry 210, which can include processor 215 and memory 200. Processing circuitry 210, processor 215 and memory 200 can have characteristics as described above for processing circuitry 180 with reference to FIG. 1, mutatis mutandis.

Application configuration agent 125A can include one or more integration units which are customized to manage particular applications in a configuration perimeter.

By way of non-limiting example: Okta integration unit 205A, AWS integration unit 205B, PostgresDB integration unit 205C, and K8S integration unit 205D can each be customized to manage a respective application according to the particular application's requirements and control/management interfaces.

Certifying authority 210 can, for example, add, delete, and otherwise manage users of an organization. Certifying authority 210 can, for example, be in communication with a public identity provider. Certifying authority 210 can perform mutual authentication with clients such as web client 155, desktop client 135, and CLI client 165, thereby establishing secure associations that can be used for encryption and for guarantee of message origin/message integrity.

Secret store 215 can store individual secrets that integration units utilize to access and configure applications.

Rogue request filtering unit 220 can perform functionality to protect applications from malicious configuration by a rogue or compromised SaaS Manager 140, as will be described below.

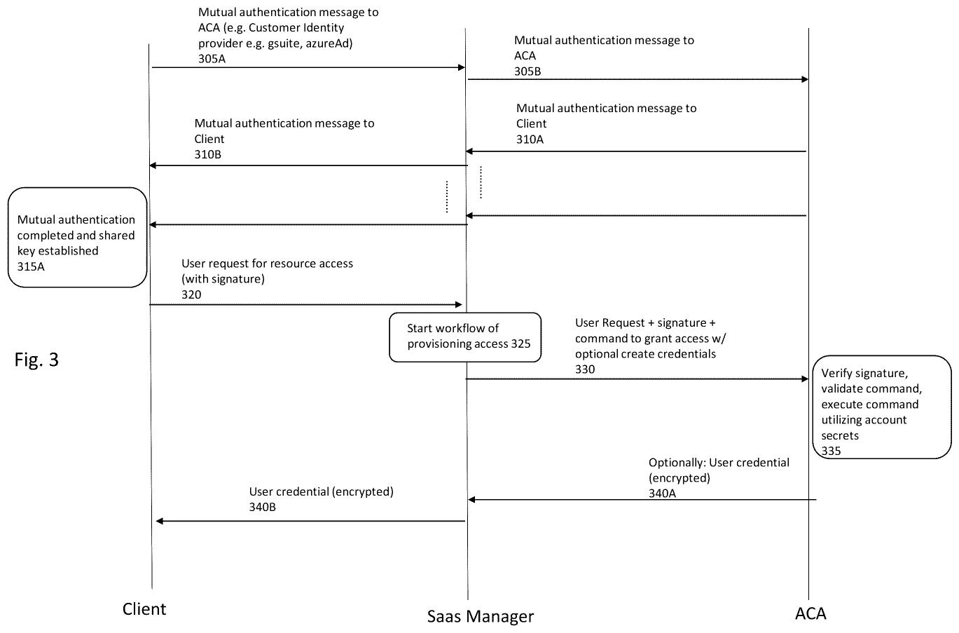

Attention is now drawn to FIG. 3, which illustrates a time diagram of an example end-to-end application configuration sequence, in accordance with some embodiments of the presently disclosed subject matter.

As described above in FIGS. 1-2, in some embodiments of the presently disclosed subject matter, application configuration agents 125A 125B 125C maintain administrator-level privileges to enable configuration of applications within their respective configuration perimeter 130A 130B 130C.

At the same time—in some embodiments—SaaS manager 140 is operated by a service provider external to the organization operating customer environment 185, yet SaaS manager 140 controls application configuration agents 125A 125B 125C. If SaaS manager 140 becomes compromised by malware, or otherwise untrustworthy, it can command application configuration agents 125A 125B 125C to perform malicious or undesired behaviors that can negatively impact the operation or privacy of the applications of the organization.

Accordingly, the present disclosure describes, in some embodiments, an architecture that enables SaaS Manager 140 to provide workflow management and administration, while enabling application configuration agents to filter and ignore any configuration commands which are not legitimately created in response to a request by an authenticated user in the organization.

The example application configuration sequence of FIG. 3 begins with a client transmitting 305A, to the SaaS manager, a message requesting mutual authentication with a specific application configuration agent. The message can utilize any suitable authentication protocol and authentication method. In some embodiments an identity provider (not shown) such Gsuite™ or AzureAd™ is utilized. The message can be sent over any transport mechanism (e.g. the internet).

SaaS Manager 140, upon receiving the mutual authentication message, can forward 305B it (e.g. unmodified) to the destination

n application configuration agent (e.g. via a preestablished authenticated connection such as a websocket). It is noted that authentication methods utilized over communication networks are resistant to man-in-the-middle attacks. Thus, if the SaaS manager is ever compromised by malware or some other fashion, it cannot misuse or hijack the mutual authentication process.

The application configuration agent can transmit a mutual authentication message 310A in response, and the SaaS Manager 140 can forward 310B it (e.g. unmodified) to the originating client. The message exchange can continue until mutual authentication is completed and e.g. one ore more shared keys have been established 315.

After the client and application configuration agent have a shared key established, the client can send a request 320, to SaaS manager 140, to access a particular resource. By way of non-limiting example, a user may make such a request in order to receive access to a particular restricted database that is located within the configuration perimeter of the application configuration agent.

In some embodiments, the client computes a cryptographic signature, using a key that is verifiable by the application configuration agent (e.g. a key derived from the mutual authentication process), and attaches the signature to the message. In some such embodiments, the client request message includes an anti-replay mechanism such as a time-stamp.

Upon receipt of the user request, SaaS manager 140 can, for example, perform 325 a workflow of access provisioning. SaaS manager 140 can, for example, employ organization-specific rules and policies to handle the user request. For example, the request might be permitted, denied, or sent to a human supervisor for approval. By way of further example, policy might impose additional restrictions on the request, such as limiting database access to a particular duration of time, or a particular mode of access.

In a case where the user request is allowed by the workflow, SaaS Manager 140 can next generate one or more commands to the application configuration agent. The application configuration agent can support, for example, a set of commands that reflect some or all of the supported configuration capabilities of the managed applications.

Some embodiments of the presently disclosed subject matter implement a method for protection of applications and resources within customer environment 185. Accordingly, SaaS Manager 140 can transmit 330 the client request (including cryptographic signature) to the application configuration agent, together with the one or more commands to the application configuration agent.

Upon receipt, the application configuration agent can then perform each of the following:
cryptographically verify 335 the signature, thereby confirming that the request originated from the particular user, and has not been altered.
validate each command of the one or more commands to the application configuration agent, to ensure that they can be derived from the user request. Thus, in some examples, a command that enables a greater level of permission than specified in the client resource request will be rejected, whereas a command that enables fewer permissions than a client resource request will be allowed.
Execute the verified and validated command, by utilizing integration-specific secrets and configuration mechanisms upon the indicated application(s)/resource(s).

In some examples, the command executed by the application configuration agent can result in establishment of a credential which a user is required to present to an application. In such cases, the application configuration agent can encrypt the credential (e.g. using a key shared by the client that is derivative of the mutual authentication procedure) and transmit 340A the encrypted credential to SaaS manager 140. SaaS manager 140 can then forward 340B the encrypted credential to the client (e.g. unmodified).

The user associated with the client can then access the desired resource or application e.g. via its usual data communication mechanism.

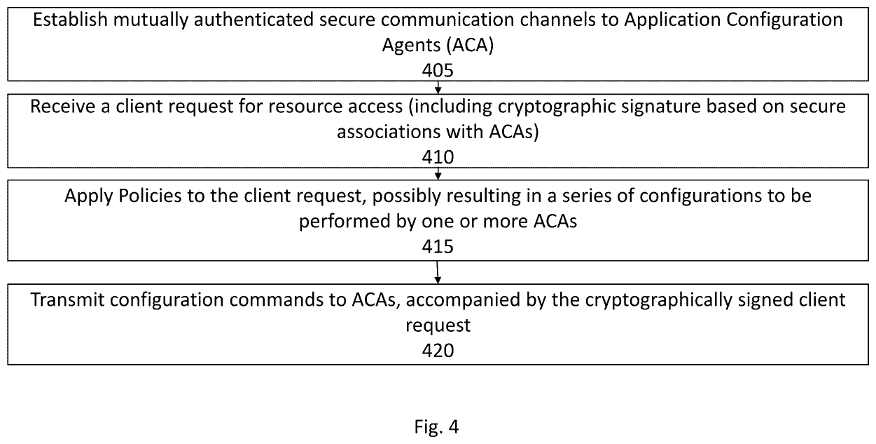

Attention is now drawn to FIG. 4, which illustrates a flow diagram of an example compromise-resistant method of receiving a client access request and commanding a application configuration agent in response to the request, in accordance with some embodiments of the presently disclosed subject matter.

Processing circuitry 180 (for example: workflow unit 150) can establish 405 a mutually authenticated secure communication channel to an application configuration agent (ACA) 125A 125B 125C. Processing circuitry 180 (for example: workflow unit 150) can do this utilizing suitable authentication and connection establishment methods as known in the art. In some examples, processing circuitry 180 (for example: workflow unit 150) can establish a websocket connection to ACA 125A 125B 125C. Processing circuitry 180 (for example: workflow unit 150) can utilize the mutually authenticated channel for transmitting commands to the ACA during workflow processing, and then receiving responses to the commands.

It is noted that in some examples, processing circuitry 180 (for example: workflow unit 150) can communicate with ACA 125A 125B 125C without mutual authentication or a secure channel (for example: when they are physically collocated).

Processing circuitry 180 (for example: workflow unit 150) can receive 410 a client request for resource access e.g. from a web client 155, desktop client 135, or CLI client 165. The client request can include, for example:
a user identifier (e.g. a user name associated with a customer environment 185)
details of an access request (e.g. specifying a particular database and a desired mode and/or duration of access)
an anti-replay mechanism (e.g. a timestamp)
a cryptographic signature, computed over at least some of the fields of the request (for example: over all the fields of the request), based on a secure association established between the identified user and the ACA

Processing circuitry 180 (for example: workflow unit 150) can next apply 415 one or more policies (e.g. as specified in workflow table 160) to the client request, possibly resulting in a series of one or more commands to be performed by an ACA.

Processing circuitry 180 (for example: workflow unit 150) can then transmit 420 configuration commands to the ACA, accompanied by the cryptographically signed client request.

In some embodiments, processing circuitry 180 (for example: workflow unit 150) transmits the cryptographically signed client request once, followed by the one or more commands to be performed by an ACA.

In some other embodiments, processing circuitry 180 (for example: workflow unit 150) transmits the cryptographically signed client request repeatedly i.e. together with each of the one or more commands to be performed by an ACA.

In some other embodiments, processing circuitry 180 (for example: workflow unit 150) transmits the cryptographically signed client request and the one or more commands to be performed by an ACA in some other arrangement.

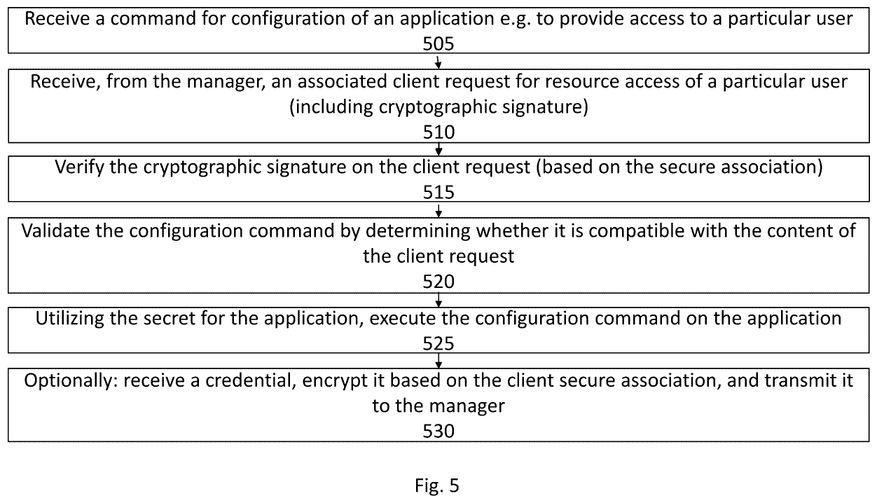

Attention is now drawn to FIG. 5, which illustrates a flow diagram of an example compromise-resistant method of configuring an application in response to commands originated by a policy workflow, in accordance with some embodiments of the presently disclosed subject matter.

Processing circuitry (e.g. rogue request filtering unit 220) can receive 505 (e.g. from SaaS Manager 140 via a websocket) one or more commands for configuration of an application e.g. to provide access to a particular user.

Each command can include, for example:
An identification of an application to be configured (e.g Okta™, PostgresDB™ etc.)
A user identifier
Details of a configuration operation (e.g. enabling access) to be performed

Processing circuitry (e.g. rogue request filtering unit 220) can further receive 510 (e.g. from SaaS Manager 140 via a websocket), a client-originated access request associated with the one or more commands for configuration of the application.

The client-originated request can include, for example:
a user identifier (e.g. a user name associated with a customer environment 185)
details of the request (e.g. requesting access, and specifying a particular database and a desired mode and/or duration of access)
an anti-replay mechanism (e.g. a timestamp)
a cryptographic signature, computed over at least some of the fields of the request, based on a secure association established between the identified user and the ACA

It is noted that processing circuitry (e.g. rogue request filtering unit 220) can receive the client-originated request prior to the one or more commands for configuration of an application.

Processing circuitry (e.g. rogue request filtering unit 220) can verify 515 the cryptographic signature on the client request (based on e.g. a shared key derived from a secure association established with the originating client), thereby ensuring that the request originated with the specified user, and has not been modified. If the verification fails, processing circuitry (e.g. rogue request filtering unit 220) can ignore commands associated with the request. As part of this verification, processing circuitry (e.g. rogue request filtering unit 220) can verify the antireplay mechanism e.g. that the included timestamp is recent (e.g. less than 1 second old)

Processing circuitry (e.g. rogue request filtering unit 220) can validate 520 each command of the one or more configuration commands by determining that it is technically appropriate to the performing of the client request. Thus, a command that enables a greater level of permission than was specified in the client request will, in some examples, be rejected, whereas a command that enables fewer permissions than a client resource request will be allowed (as the reduction in permission may have legitimately been implemented by policy). If the validation fails, processing circuitry (e.g. rogue request filtering unit 220) can ignore commands associated with the request.

Subsequent to verification of the signature and validation of the command, processing circuitry (e.g. an integration such as Okta integration unit 205A, AWS integration unit 205B, PostgresDB integration unit 205C, or Kubernetes integration unit 205D) can, utilizing a stored secret for the respective application, execute 525 the configuration command (e.g. to provide access to a particular user) on the respective application.

In some examples, processing circuitry (e.g. an integration such as Okta integration unit 205A, AWS integration unit 205B, PostgresDB integration unit 205C, or Kubernetes integration unit 205D) can receive 530 a credential (or “secret”) for use by the user. In this case, processing circuitry (e.g. rogue request filtering unit 220) can encrypt the received credential using an encryption key of the web client 155, desktop client 135, or CLI client 165 (e.g. an encryption key derivative of the shared security association between the ACA and the respective client). Processing circuitry (e.g. rogue request filtering unit 220) can then transmit the encrypted key to toward the client (e.g. via SaaS Manager) 140.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A system of compromise-resistant configuration of an application, the system comprising a processing circuitry configured to:
a) utilize an authenticated secure communication channel to a configuration agent, the configuration agent having access to one or more secrets, associated with a first organization, usable for configuring respective applications of the first organization;
b) receive, from a first user, a request of configuration of an application, the request including a cryptographic signature of a first user of the first organization, the signature utilizing a key derivative of a mutual authentication between the first user and the configuration agent;
c) derive, from the received request of configuration of the first user, a one or more application configuration commands;
d) transmit, to the application configuration agent, via the authenticated secure communication channel, at least:
i) at least part of the request of configuration of the first user, wherein the at least part of the request comprises the cryptographic signature, and
ii) at least one of the derived application configuration commands;
thereby providing an attestation of integrity to application configuration commands.

2. A processing circuitry-based method of compromise-resistant configuration of an application, the method comprising:
a) utilizing an authenticated secure communication channel to a configuration agent, the configuration agent having access to one or more secrets, associated with a first organization, usable for configuring respective applications of the first organization;
b) receiving, from a first user, a request of configuration of an application, the request including a cryptographic signature of a first user of the first organization, the signature utilizing a key derivative of a mutual authentication between the first user and the configuration agent;
c) deriving, from the received request of configuration of the first user, a one or more application configuration commands;
d) transmitting, to the application configuration agent, via the authenticated secure communication channel, at least:
i) at least part of the request of configuration of the first user, wherein the at least part of the request comprises the cryptographic signature, and
ii) at least one of the derived application configuration commands;
thereby providing an attestation of integrity to application configuration commands.

3. A computer program product comprising a computer readable non-transitory storage medium containing program instructions, which program instructions when read by a processor, cause the processing circuitry to perform a method of compromise-resistant configuration of an application, the method comprising:
a) utilizing an authenticated secure communication channel to a configuration agent, the configuration agent having access to one or more secrets, associated with a first organization, usable for configuring respective applications of the first organization;
b) receiving, from a first user, a request of configuration of an application, the request including a cryptographic signature of a first user of the first organization, the signature utilizing a key derivative of a mutual authentication between the first user and the configuration agent;
c) deriving, from the received request of configuration of the first user, a one or more application configuration commands;
d) transmitting, to the application configuration agent, via the authenticated secure communication channel, at least:
i) at least part of the request of configuration of the first user, wherein the at least part of the request comprises the cryptographic signature, and
ii) at least one of the derived application configuration commands;
thereby providing an attestation of integrity to application configuration commands.

4. A system of compromise-resistant configuration of an application, the system comprising a processing circuitry configured to:
a) maintain application-specific configuration secrets of a first organization, and utilize an authenticated secure communication channel to a manager;
b) perform mutual authentication to establish a secure association with a first user of the first organization;
c) receive, from the manager, at least:
i) a request of the first user of application configuration, the request including a cryptographic signature of the first user, and
ii) one or more commands of configuring a first application;
d) responsive to:
i) based on the secure association with the first user, cryptographically verifying the first user as the origin of the request, and verifying the message integrity of the request, and that the signature of the request is of the first user, and
ii) verifying that the one or more commands of configuring are technically appropriate to performing the received request of the first user,
utilize a secret specific to the first application to configure the first application, in accordance with the one or more commands.

5. The system of claim 2, wherein the processing circuitry is further configured to:
e) receive a credential from the first application;
f) encrypt the credential using an encryption key decryptable by the first user; and
g) transmit the encrypted credential to the management system via the secure authenticated channel.

6. A processing circuitry-based method of compromise-resistant configuration of an application, the method comprising:
a) maintaining application-specific configuration secrets of a first organization, and utilizing an authenticated secure communication channel to a manager;
b) performing mutual authentication to establish a secure association with a first user of the first organization;
c) receiving, from the manager, at least:
i) a request of the first user of application configuration, the request including a cryptographic signature of the first user, and
ii) one or more commands of configuring a first application;
d) responsive to:
i) based on the secure association with the first user, cryptographically verifying the first user as the origin of the request, and verifying the message integrity of the request, and that the signature of the request is of the first user, and
ii) verifying that the one or more commands of configuring are technically appropriate to performing the received request of the first user,
utilizing a secret specific to the first application to configure the first application, in accordance with the one or more commands.

7. A computer program product comprising a computer readable non-transitory storage medium containing program instructions, which program instructions when read by a processor, cause the processing circuitry to perform a method of compromise-resistant configuration of an application, the method comprising:
a) maintaining application-specific configuration secrets of a first organization, and utilizing an authenticated secure communication channel to a manager;
b) performing mutual authentication to establish a secure association with a first user of the first organization;
c) receiving, from the manager, at least:
i) a request of the first user of application configuration, the request including a cryptographic signature of the first user, and
ii) one or more commands of configuring a first application;
d) responsive to:
i) based on the secure association with the first user, cryptographically verifying the first user as the origin of the request, and verifying the message integrity of the request, and that the signature of the request is of the first user, and
ii) verifying that the one or more commands of configuring are technically appropriate to performing the received request of the first user.
utilizing a secret specific to the first application to configure the first application, in accordance with the one or more commands.
